(19) United States
(12) Patent Application Publication
(10) Pub. No.: US 2026/0228668 A1
(43) Pub. Date: Aug. 6, 2026

(54) CROSS STORE PERFORMANCE METRIC ANALYSIS

(71) Applicant: NCR Voyix Corporation, Atlanta, GA (US)

(72) Inventors: Noa Shmulevich, Haifa (IL); Itamar David Laserson, Givat Shmuel (IL)

(21) Appl. No.: 19/042,356

(22) Filed: Jan. 31, 2025

(51) Int. Cl. G06Q 10/0637; G06Q 10/0639

(52) U.S. Cl. CPC G06Q 10/06375; G06Q 10/06393

(57) ABSTRACT

Methods and system analyze retail store performance metrics to normalize key performance indicators (KPIs) across multiple stores and enable meaningful comparisons. A quantile transformation is applied to each KPI's distribution, generating a first impact value, followed by calculating a second impact value representing the distance from the distribution's median. Transformed values are then sorted in a two-step process—by the first impact value and then by the second impact value—to create a prioritized list of KPIs. The sorted results are presented through an interface, enabling regional managers to efficiently identify stores and specific performance areas requiring improvement. This ensure a balanced evaluation across different KPIs regardless of their original value ranges or distributions, while maintaining independent computation of each metric, preventing individual KPIs from dominating the analysis and providing regional managers with actionable insights for improving overall retail chain performance.

### BACKGROUND

Regional managers overseeing multiple retail stores face significant challenges when comparing different key performance indicators (KPIs) across their stores due to varying value ranges and distributions, making it difficult to identify which stores truly require improvement in specific areas. Traditional normalization methods like min-max or standard normalization can cause certain KPIs to overshadow others when they come from different distributions, leading to biased comparisons. Additionally, since each KPI is calculated independently in separate processing runs, managers need a reliable way to compare across KPIs while preserving their independent computation, making it challenging to draw meaningful conclusions about store performance and prioritize necessary improvements.

### BRIEF DESCRIPTION OF THE DRAWINGS

FIG. 1 is a diagram of a system for cross store performance metric analysis, according to an example embodiment.

FIG. 2 is a flow diagram of a method for performing cross store performance metric analysis, according to an example embodiment.

FIG. 3 is a flow diagram of another method for performing cross store performance metric analysis, according to an example embodiment.

### DETAILED DESCRIPTION

As stated above, regional managers overseeing multiple retail stores face significant challenges when comparing and evaluating different key performance indicators (KPIs) across their stores. A fundamental issue arises from KPIs having different ranges of values, which makes direct comparisons between stores impossible. When attempting to analyze store performance, simple normalization methods such as min-max or standard normalization bring all KPIs to the same scale but create new complications.

Existing normalization techniques can cause certain KPIs to overshadow others, particularly when the KPIs originate from different distributions. For example, sorting by normalized values can result in bias between the KPIs, where one KPI appears more important than another solely because it has higher values. This creates a distorted view of store performance that doesn't accurately reflect areas requiring improvement.

A further complication stems from each KPI being calculated independently in separate processing runs. This independent computation, while necessary, creates additional complexity in developing a unified technique for comparing across different KPIs while maintaining their separate calculation processes.

These technical challenges create specific problems in computer-implemented retail analytics systems. The independent computation requirements of different KPIs across distributed point-of-sale systems result in data processing inefficiencies and potential data inconsistencies when attempting cross-store performance comparisons. Traditional normalization approaches implemented in computer systems lead to processing overhead and can produce misleading results when KPIs from different statistical distributions are compared, causing systems to generate incorrect prioritization of performance metrics.

The technical solution and teachings presented herein overcomes these challenges through a novel two-step computational approach that enables efficient processing of independently calculated KPIs while maintaining data consistency across distributed systems. The quantile transformation and median distance calculation provide a computationally efficient method for normalizing disparate KPI distributions, while the cloud-based architecture enables real-time aggregation and processing of performance data across multiple retail locations. This solution significantly reduces processing overhead compared to traditional normalization methods, eliminates data inconsistencies in cross-store comparisons, and enables dynamic updating of performance metrics without requiring reprocessing of the entire dataset.

The embodiments presented herein transform each KPI through a two-step process that enables meaningful comparisons while preserving independent computation. First, a quantile transformation converts each KPI's distribution to a uniform distribution between 0 and 1, which prevents KPIs with naturally higher value ranges from dominating the analysis. Second, the distance from the normalized distribution's median is calculated for each value, providing an additional metric for comparing extreme values across different KPIs while maintaining their independent significance.

The teachings provided herein deliver several key benefits. Regional managers can gain more meaningful insights regarding their chain and easily identify areas that require actions. The transformation and sorting methods ensure a balanced view of store performance, preventing any single KPI from dominating the analysis. T his creates a clearer overall perspective of store performance across the entire chain.

Furthermore, this method is robust and adaptable, working effectively across all possible KPI distributions and any number of KPIs. The system maintains its effectiveness even when new KPIs are introduced, requiring no modifications to accommodate additional performance metrics. The strategic value of the teachings presented herein extends beyond basic performance analysis, enabling regional managers to identify and focus on the most important recommendations, saving valuable time while facilitating data-driven decision making.

The teachings herein provide actionable value from data stored in enterprise data and information warehouses. By leveraging past data collected in warehouses and application logs, the teachings enable valuable software services that benefit retail customers. Additionally, the teachings provide current and future retail customers motivation to migrate to business services platforms and adopt cloud-based solutions.

From a commercial perspective, the teachings are designed as a business services platform (BSP) service that can be consumed through a software-as-a-service (SaaS) model. This implementation delivers significant advantages through its cloud-based architecture. As a centralized BSP service, it requires minimal maintenance with development and updates managed from one central location by a single team serving all retail customers.

The teachings presented herein demonstrate remarkable adaptability and longevity. The module/algorithm provided herein automatically learns from experience, allowing it to adjust to changing sales patterns over time. This self-tuning capability ensures the system remains relevant and effective as business conditions evolve. Furthermore, the solution is inherently generic, applicable to any analytics' tenants without requiring customization, and can interface with any point-of-sale (POS) system connected to the platform.

The dashboard interface, discussed below, provides dynamic visualization capabilities that enable regional managers to interact with and manipulate the displayed KPI data in real-time. When a manager selects specific stores or KPI types through the interface, the system automatically recalculates and updates the normalized distributions and impact values, providing immediate visual feedback on relative store performance.

The cloud-based architecture enables real-time aggregation of KPI data across all stores in the retail chain. As new transaction data flows into the system from point-of-sale terminals, the transformer manager, discussed herein and below, continuously updates the normalized distributions and impact values. This allows regional managers to identify emerging performance trends as they develop.

The interface, provided herein, includes interactive filtering capabilities that allow managers to focus their analysis on specific time periods, store clusters, or KPI categories. When a manager applies filters through the interface, the system dynamically regenerates the prioritized recommendations based on the filtered dataset while maintaining the two-step normalization process to ensure fair comparisons.

The solution provides significant operational advantages through its centralized architecture. Development and maintenance are managed from a single central location by one dedicated team serving all customers, eliminating the need for individual customer implementations. This centralized approach ensures consistent performance analysis across all retail operations while minimizing maintenance overhead and enabling rapid deployment of improvements.

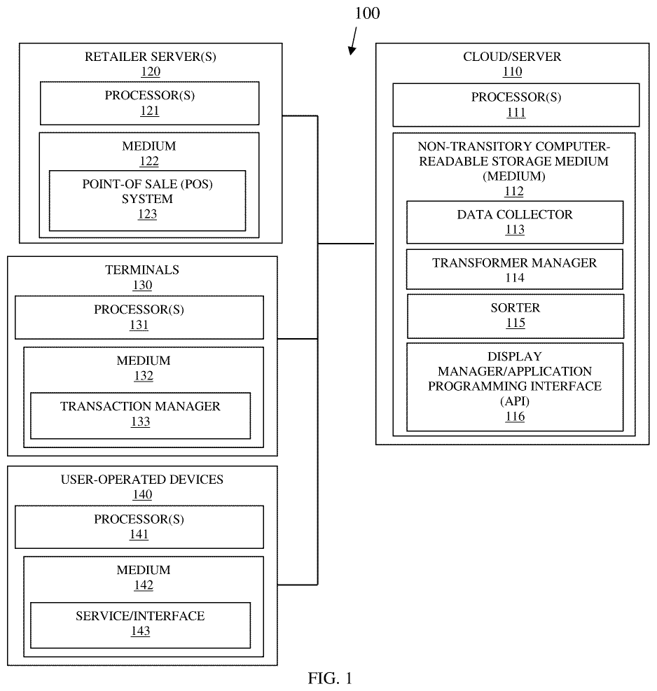

FIG. 1 is a diagram of a system 100 for performing cross store performance metric analysis, according to an example embodiment. Notably, the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of performing cross store performance metric analysis, presented herein and below.

System 100 includes a cloud 110 or server, one or more retailer servers 120, one or more terminals 130, and one or more user-operated devices 140. Cloud 110 includes at least one processor 111 and a non-transitory computer-readable storage medium 112 (medium), which includes instructions for a data collector 113, a transformer manager 114, a sorter 115, and display manager/application programming interface (API) 116. The instructions when executed by the processor 111 cause the processor 111 to perform operations discussed herein and below with respect to 113-116.

Each retail server 120 includes at least one processor 121 and a medium 122, which includes instructions for a point-of-sale (POS) system 123. The instructions when executed by the processor 121 cause the processor 121 to perform the operations discussed herein and below with respect to POS system 123.

Each terminal 130 includes at least one processor 131 and a medium 132, which includes instructions for a transaction manager 133. The instructions when executed by the processor 131 cause the processor 131 to perform the operations discussed herein and below with respect to transaction manager 133.

Each user-operated device 140 includes at least one processor 141 and a medium 142, which includes instructions for a service/interface 143. The instructions when executed by the processor 151 cause the processor 151 to perform operations discussed herein and below with respect to 143.

Initially, data collector 113 collects analytic performance data for retail stores of a chain from POS system 123. In an embodiment, data collector 113 utilizes an API to obtain the analytic performance data. In an embodiment, the analytic performance data are key performance indicators (KPIs) or metrics that span multiple stores in the retail chain. Each KPI is associated with a value along a scale or distribution, which is unique to each store.

Transformer manager 114 organizes the analytic performance data by type. For example, a sales KPI, a staff turnover KPI, a weekly sales KPI, monthly sales KPI, an average amount of time spent per transaction KPI, a sales generated per square foot of a store, a year-over-year sales KPI, a revenue contribution for a specific product or category of products KPI, a percentage of store visitors making a purchase KPI, foot traffic within a store, average transactions per a given time period, business KPIs focused on store performance improvement, and others.

The transformer manager 114 creates a distribution of values for each analytic performance data type of each store. For example, assume there are 5 store A, store B, store C, store D, and store E with 3 KPI types, sales, foot traffic, and average transaction volume. The KPI values for each of the 5 stores are the 3 KPIs are as follows:

| Store | Sales | Foot Traffic | Average Transaction Volume |
|---|---|---|---|
| A | 150 | 500 | 30 |
| B | 180 | 550 | 40 |
| C | 200 | 600 | 45 |
| D | 250 | 800 | 50 |
| E | 500 | 1500 | 100 |

Transformer manager 114 unifies the distribution across each KPI type, sorts from lowest to highest the KPI values, and computes the quantile rank of each type of KPI and its value; Quantile Rank=(Rank−1)/total Number of KPI values−1. This transformation ensures that KPIs with naturally higher values or different distributions do not create bias in the analysis. For example, for the sales KPI type of the five stores, the unified distribution and corresponding unified and normalized KPI values are as follows:

| Sales KPI VALUE | Rank | Quantile Rank |
|---|---|---|
| 150 | 1 | 0.0 |
| 180 | 2 | 0.25 |
| 200 | 3 | 0.50 |
| 250 | 4 | 0.75 |
| 500 | 5 | 1.00 |

After, transformer manager 114 is completed there is a uniform distribution and normalized KPI value for each KPI type within the uniform distribution for stores A-E, the results appears as follows:

| | | | Avg. | | | Avg |
|---|---|---|---|---|---|---|
| Store | Sales | Traffic | Trans | Sales Q | Traffic Q | Trans |
| A | 150 | 500 | 30 | 0.0 | 0.0 | 0.0 |
| B | 180 | 550 | 40 | 0.25 | 0.25 | 0.25 |
| C | 200 | 600 | 45 | 0.5 | 0.5 | 0.5 |
| D | 250 | 800 | 50 | 0.75 | 0.75 | 0.75 |
| E | 500 | 2500 | 100 | 1.0 | 1.0 | 1.0 |

Transformer manager 114 retains the mapped unified and normalized KPI values for each KPI type of each store as an impact 1 value. Next, transformer manager 114 finds impact 2 values for the impact 1 values in the uniform distribution. Because the uniform distribution was mapped between 0 and 1 for each KPI type, the median is 0.5.

Once the median for the uniform distribution is know and the impact 1 values are known, transformer manager 114 calculates the impact 2 value for each store's KPI by calculating the distance of each KPI value from the median of the KPI distribution (e.g., KPI value/KPI median value):

| Store | Sales Q Dist. | Traffic Q. Dist. | Avg. Trans Dis |
|---|---|---|---|
| A | 0.75 | 0.83 | 0.6 |
| B | 0.9 | 0.91 | 0.8 |
| C | 1 | 1 | 1 |
| D | 1.25 | 1.3 | 1.1 |
| E | 2.5 | 2.51 | 2.2 |

Because extreme impact 1 values for KPIs map to 1 in the uniform distribution, the impact 2 values provide an additional metric to sort the KPI values in the uniform distribution. A high impact 2 value indicates a sample KPI value is an outlier compared to the rest of the uniform KPI values in the uniform distribution such that the impact 2 values can be used to compare between extreme KPI values within the uniform distribution.

For example, consider two KPIs where point A in the first KPI distribution and point B in the second KPI distribution both map to extreme values in their respective uniform distributions. While point B may have a larger raw value, point A could be identified as more significant if its impact 2 value (distance from median) is greater, demonstrating how the two-step process enables meaningful comparison between KPIs with different natural distributions.

Sorter 115 sorts the KPI values impact 1 values and impact 2 values. Display manager 116 or an API 116 provides the sorted list to a service 143 or an interface 143 being accessed by a regional manager of stores via a user-operated device 140. In an embodiment, API 116 provides the doubly sortable list of unified and normalized KPI values (i.e., impact 1 values) and impact 2 values across stores to a dashboard service 143 or a dashboard interface 143. The regional manager sees the stores with the KPIs of the stores sorted by the scores associated with the impact 1 and 2 values. This provides an apples-to-apples comparison to the regional manager with readily discernible recommendations on which KPI types of which stores require the regional manager's attention and action. The sortable list enables regional managers to gain meaningful insights regarding their chain by presenting a balanced view of store performance metrics that prevents any single KPI from dominating the analysis, allowing them to easily identify and prioritize areas requiring improvement actions.

In an embodiment, KPI evaluations and analysis for cross or different stores can be executed independently and separately by system 100 while still maintaining a reliable approach to rank and sort the different KPI evaluations of the cross stores. System 100 works across all KPI distributions for any number of KPIs. Even if a new KPI is introduced by a store in the future, system 100 does not require any modification to handle the new KPI being introduced for a first time. In this way, system 100 is adaptable and learns without any modifications required to the source code or logic of system 100.

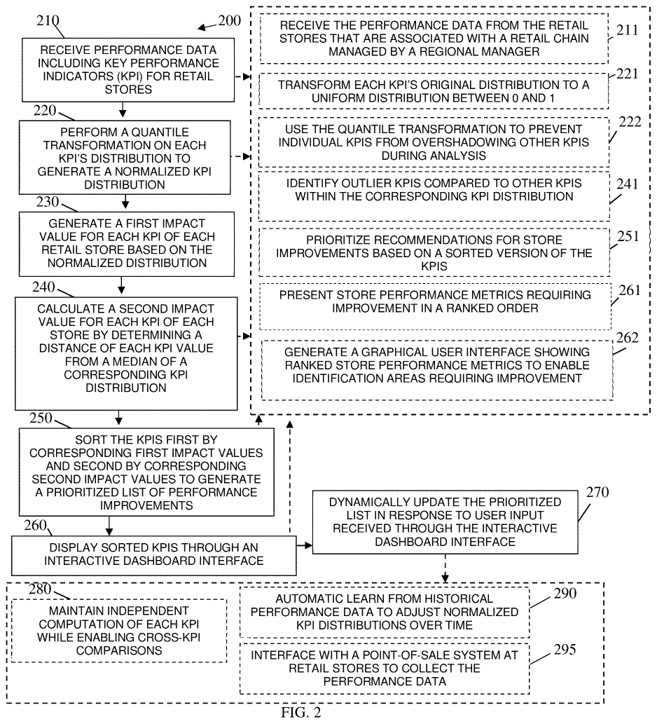

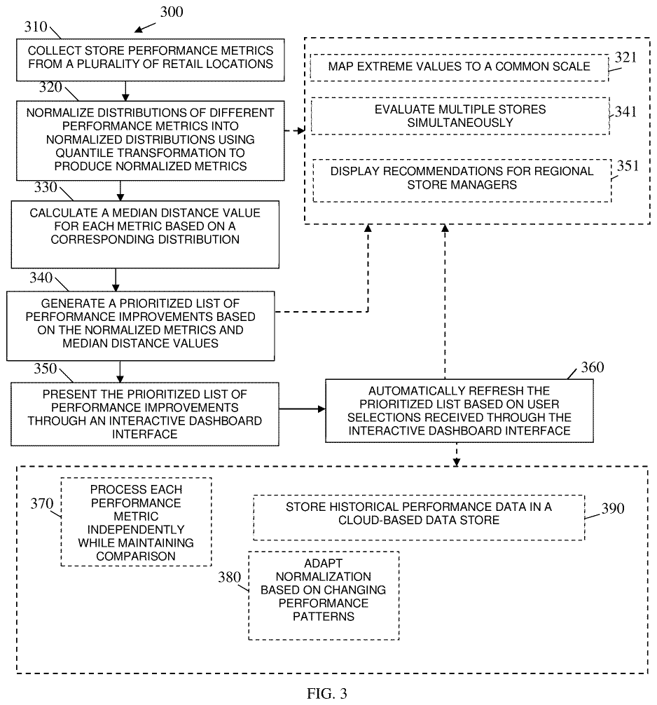

The above-referenced embodiments and other embodiments are now discussed within FIGS. 2-3. FIG. 2 is a flow diagram of a method 200 for performing cross store performance metric analysis, according to an example embodiment. The software module(s) that implements the method 200 is referred to as a “cross store metric analyzer.” The cross store metric analyzer is implemented as executable instructions programmed and residing within memory and/or a non-transitory computer-readable (processor-readable) storage medium and executed by one or more processors of one or more devices. The processor(s) of the device that executes the cross store metric analyzer are specifically configured and programmed to process the cross store metric analyzer. The cross store metric analyzer may have access to one or more network connections during its processing. The network connections can be wired, wireless, or a combination of wired and wireless.

In an embodiment, the device that executes the cross store metric analyzer is cloud 110. In an embodiment, the device that execute the cross store metric analyzer is retailer server 120. In an embodiment, the cross store metric analyzer is all or some combination of data collector 113, transformer manager 114, sorter, and/or display manager/API 116.

At 210, the cross store analyzer receives performance data. The performance data includes KPIs for retail stores. In an embodiment, at 211, the cross store metric analyzer receives the performance data from the retail stores that are associated with a retail chain managed by a regional manager.

At 220, the cross store metric analyzer performs a quantile transformation on each KPI's distribution to generate a normalized KPI distribution, In an embodiment, at 221, the cross store metric analyzer transforms each KPI's original distribution to a uniform distribution between 0 and 1. In an embodiment, at 222, the cross store metric analyzer uses the quantile transformation to prevent individual KPIs from overshadowing other KPIs during analysis.

At 230, the cross store metric analyzer generates a first impact value for each KPI of each retail store based on a corresponding normalized distribution. At 240, the cross store metric analyzer calculates a second impact value for each KPI of each store by determining a distance of each KPI value from a median of the corresponding KPI distribution. In an embodiment, at 241, the cross store metric analyzer identify outlier KPIs compared to other KPIs within the corresponding KPI distribution.

At 250, the cross store metric analyzer sorts the KPIs first by corresponding first impact values and second by corresponding second impact values to generate a prioritized list of performance improvements. In an embodiment, at 251, the cross store metric analyzer prioritizes recommendations for store improvements based on a sorted version of the KPIs.

At 260, the cross store metric analyzer displays sorted KPIs in an interactive dashboard interface. In an embodiment, at 261, the cross store metric analyzer presents store performance metrics requiring improvement in a ranked order. In an embodiment, at 262, the cross store metric analyzer generates a graphical user interface showing ranked store performance metrics to enable identification areas requiring improvement.

In an embodiment, at 270, the cross store metric analyzer dynamically updates the prioritized list in response to user input received through the interactive dashboard interface. In an embodiment, at 280, the cross store metric analyzer maintains independent computation of each KPI while enabling cross-KPI comparisons.

In an embodiment, at 290, the cross store metric analyzer automatically learns from historical performance data to adjust normalized KPI distributions over time. In an embodiment, at 295, the cross store metric analyzer interfaces with a POS system at retail stores to collect the performance data or to calculate the performance data on behalf of the retail stores.

FIG. 3 is a diagram of another method 300 for performing cross store performance metric analysis, according to an example embodiment. The software module(s) that implements the method 300 is referred to as a “key performance indicator (KPI) normalizer.” The KPI normalizer is implemented as executable instructions programmed and residing within memory and/or a non-transitory computer-readable (processor-readable) storage medium and executed by one or more processors of a device. The processors that execute the KPI normalizer are specifically configured and programmed for processing the KPI normalizer. The KPI normalizer may have access to one or more network connections during its processing. The network connections can be wired, wireless, or a combination of wired and wireless.

In an embodiment, the device that executes the KPI normalizer is cloud 110. In an embodiment, the device that executes the KPI normalizer is retailer server 120. In an embodiment, the KPI normalizer r is all or some combination of data collector 113, transformer manager 114, sorter 115, display manager/API 116, and/or method 200 of FIG. 2. The KPI normalizer presents another, and in some ways an enhanced processing perspective from that which was described above with method 200 of FIG. 2.

At 310, the KPI normalizer collects store performance metrics from a plurality of retail locations. At 320, the KPI normalizer normalizes distributions of different performance metrics into normalized distributions using quantile transformation to produce normalized metrics. In an embodiment, at 321, the KPI normalizer maps extreme values to a common scale.

At 330, the KPI normalizer calculates a median distance value for each metric based on a corresponding distribution. At 340, the KPI normalizer generates a prioritized list of performance metrics based on the normalized metrics and median distance values. In an embodiment, at 341, the KPI normalizer evaluates multiple stores simultaneously.

At 350, the KPI normalizer presents the prioritized list of performance improvements through an interactive dashboard interface. In an embodiment, at 351, the KPI normalizer displays recommendations for regional store managers.

At 360, the KPI normalizer automatically refreshes the prioritized list based on user selections received through the interactive dashboard interface. In an embodiment, at 370, the KPI normalizer processes each performance metric independently while maintaining comparison capabilities across different stores.

In an embodiment, at 380, the KPI normalizer adapts normalization based on changing performance patterns associated with the stores. In an embodiment, at 390, the KPI normalizer stores historical performance data in a cloud-based data store.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving performance data comprising key performance indicators (KPIs) for retail stores;
performing a quantile transformation on each updated KPI's distribution to generate a normalized KPI distribution;
generating a first impact value for each KPI of each retail store based on the normalized KPI distribution;
calculating a second impact value for each KPI of each store by determining a distance of each corresponding KPI value from a median of a corresponding KPI distribution;
sorting the KPIs first by corresponding first impact values and second by corresponding second impact values to generate a prioritized list of performance improvements;
displaying the prioritized list of performance improvements through an interactive dashboard interface; and
dynamically updating the prioritized list of performance improvements that is displayed in response to user input received through the interactive dashboard interface.

2. The method of claim 1, wherein receive comprises receiving the performance data from the retail stores that are associated with a retail chain managed by a regional manager.

3. The method of claim 1, wherein performing comprises transforming each KPI's original distribution to a uniform distribution between 0 and 1.

4. The method of claim 1, wherein performing comprising using the quantile transformation to prevent individual KPIs from overshadowing other KPIs during analysis.

5. The method of claim 1, wherein calculating the second impact value comprises identifying outlier KPIs compared to other KPIs within the corresponding KPI distribution.

6. The method of claim 1, wherein sorting comprises prioritizing recommendations for store improvements based on a sorted version of the KPIs.

7. The method of claim 1, wherein displaying comprises presenting store performance metrics requiring improvement in a ranked order.

8. The method of claim 1, wherein displaying comprises generating a graphical user interface showing ranked store performance metrics to enable identification of areas requiring improvement.

9. The method of claim 1, further comprising maintaining independent computation of each KPI while enabling cross-KPI comparisons.

10. The method of claim 1, further comprising automatically learning from historical performance data to adjust normalized KPI distributions over time.

11. The method of claim 1, further comprising interfacing with point-of-sale systems at the retail stores to collect the performance data.

12. A method, comprising:
collecting store performance metrics from a plurality of retail locations;
normalizing distributions of different performance metrics into normalized distributions using quantile transformation to produce normalized metrics;
calculating a median distance value for each metric based on a corresponding distribution;
generating a prioritized list of performance improvements based on the normalized metrics and corresponding median distance values;
presenting the prioritized list of performance improvements through an interactive dashboard interface; and
automatically refreshing the prioritized list of performance improvements that is presented based on user selections received through the interactive dashboard interface.

13. The method of claim 12, wherein normalizing comprises mapping extreme values to a common scale.

14. The method of claim 12, wherein generating comprises evaluating multiple stores simultaneously.

15. The method of claim 12, wherein presenting comprises displaying recommendations for regional store managers.

16. The method of claim 12, further comprising processing each performance metric independently while maintaining comparison capability.

17. The method of claim 12, further comprising adapting normalization based on changing performance patterns.

18. The method of claim 12, further comprising storing historical performance data in a cloud-based data store.

19. A system, comprising:
data collector instructions configured to execute on a processor and collect performance indicators from retail stores;
transformer manager instructions configured to execute on the processor and normalize distributions of the performance indicators and calculate median distance values;
sorter instructions configured to execute on the processor and prioritize normalized performance indicators based on the median distance values; and
display manager instructions configured to execute on the processor and present prioritized performance metrics through a dashboard interface.

20. The system of claim 19, wherein the transformer manager instructions are further configured to cause the processor to maintain independent processing of each performance indicator while enabling cross-indicator comparison.
